(19) United States
(12) Patent Application Publication
(10) Pub. No.: US 2009/0085704 A1
(43) Pub. Date: Apr. 2, 2009

(54) CHIP INDUCTOR

(75) Inventor: Horst Theuss, Wenzenbach (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: Infineon Technologies Austria AG, Villach (AT)

(21) Appl. No.: 11/865,122

(22) Filed: Oct. 1, 2007

(51) Int. Cl. H01F 5/00; H01F 7/06

(52) U.S. Cl. 336/200; 29/602.1; 29/607

(57) ABSTRACT

A chip inductor includes a first substrate and a second substrate. The first substrate includes at least one first conductive strip line having end terminals at a surface of the first substrate and the second substrate includes at least one second conductive strip line having end terminals at a surface of the second substrate, wherein a pitch of the end terminals on the first substrate corresponds to a pitch of the end terminals on the second substrate. Furthermore, conductive studs are provided which connect the end terminals on the first substrate with the end terminals on the second substrate to form an inductor loop.

### BACKGROUND

One aspect relates to a semiconductor device having an integrated inductance, and relates to a chip inductor.

Inductor devices according to the state of the art have a large number of processing steps such that the costs for manufacturing such devices are high. Furthermore, with conventional inductors the component size is large and long wiring lengths have to be provided.

Flat inductors that are integrated in multi layer substrates or semiconductors have inductivities that are low due to missing core elements which increase the magnetic field strength considerably.

### SUMMARY

One aspect provides an inductor which can be integrated into a semiconductor circuit allowing a large inductivity and small size.

According to a first aspect, a chip inductor is provided which includes a first substrate, includes at least one first conductive strip line having end terminals at a surface of the first substrate, a second substrate, including at least one second conductive strip line having end terminals at a surface of the second substrate, wherein a pitch of the end terminals on the first substrate corresponds to a pitch of the end terminals on the second substrate, and conductive studs connecting the end terminals on the first substrate with the end terminals on the second substrate to form an inductor loop.

According to a further aspect, a method for manufacturing a chip inductor is provided that includes providing a first substrate; depositing at least one first conductive strip line having end terminals onto the first substrate; providing a second substrate; depositing at least one second conductive strip line having end terminals onto the second substrate, wherein a pitch of the end terminals on the first substrate corresponds to a pitch of the end terminals on the second substrate; depositing conductive studs onto the end terminals on the first and/or the second substrate; and arranging the first substrate with respect to the second substrate such that the conductive studs connect the end terminals on the first substrate with the end terminals on the second substrate to form an inductor loop.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

Embodiments are depicted in the drawings and are detailed in the description which follows.

FIG. 1(a) illustrates a first substrate having first conductive strip lines deposited onto an upper surface.

FIG. 1(b) illustrates the first substrate illustrated in FIG. 1(a) wherein first and second conductive studs have been deposited onto the first conductive strip lines at the end terminals thereof.

FIG. 2(a) illustrates the arrangement illustrated in FIG. 1(b) with a first magnetically soft core element arranged between the first and second conductive studs and onto the surface of the first substrate where the first conductive strip lines are deposited.

FIG. 2(b) illustrates the first substrate prepared identically to the arrangement illustrated in FIG. 2(a) but turned by 180 degrees such that the first and second studs point downwards.

FIG. 3 illustrates the first substrate with the first and second conductive studs pointing downwards and a second substrate having second conductive strip lines deposited on it.

FIG. 4 illustrates the arrangement of FIG. 3 wherein the first and second substrate have been put together such that the first and second conductive studs contact the second conductive strip lines.

FIG. 5(a) illustrates the arrangement depicted in FIG. 4 with magnetic field lines, wherein first magnetic field lines are above the first substrate and second magnetic field lines pass through the second substrate.

FIG. 5(b) is a sectional view showing a cross section along the centre of an inductor element.

FIG. 6(a) illustrates the arrangement of FIG. 4 with an additional applied second magnetically soft core element arranged at the first substrate on a surface opposite to the surface where the first and second conductive studs are arranged, wherein first magnetic field lines are illustrated.

FIG. 6(b) depicts first magnetic field lines in a cross section taken along the axis of the inductor element.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

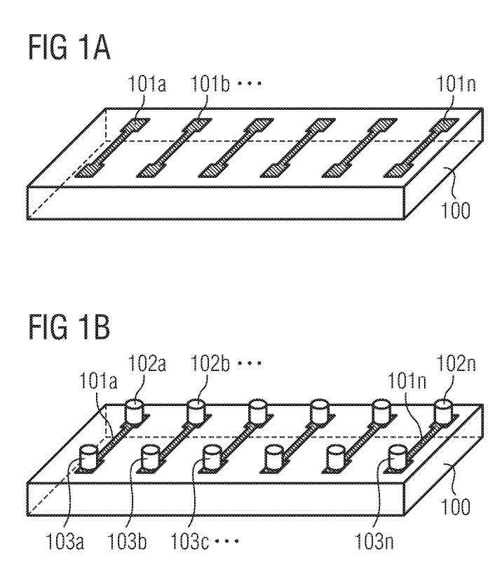

With reference to FIGS. 1-5 a first embodiment will be described. FIGS. 1-4 illustrate steps for manufacturing an inductor element and a flip chip inductor, respectively.

One aspect provides two separate substrates which cooperate in forming an inductor having small size and high inductivity. The wiring of the inductor is divided into two separate inductor elements which are provided separately on two substrates. Typically the substrates are semiconductor substrates, while other substrates like an organic circuit board substrate, thermoplastic substrate, glass or combinations thereof may also be used.

One (or both) of the two substrates contains a magnetic element in the form of a magnetic layer. Materials like Fe or alloys on bases of Fe, NiFe, SiFe, or FeSiB can be used.

In one embodiment, high inductivities may be provided. The “chip-on”-technology is easily realised using semiconductor chips. The wiring lengths are short such that good RF characteristics may be provided. A further embodiment of the inductor according to the present application is that it may be integrated into a semiconductor substrate in an efficient and easy way.

According to a first aspect, a chip inductor is provided which includes a first substrate, including at least one first conductive strip line having end terminals at a surface of the first substrate, a second substrate, including at least one second conductive strip line having end terminals at a surface of the second substrate, wherein a pitch of the end terminals on the first substrate corresponds to a pitch of the end terminals on the second substrate, and conductive studs connecting the end terminals on the first substrate with the end terminals on the second substrate to form an inductor loop. Thus the first and second strip lines and the conductive studs cooperate to form the inductor loop (or several inductor loops) such that the magnetic field generated in the centre of the inductor loop is oriented substantially parallel to the surfaces of the first and second substrates.

According to one embodiment, the conductive studs include copper or copper alloys.

According to yet another development, the inductor further includes a second magnetic element arranged at the first substrate on a surface opposite to the surface where the first magnetic element is arranged. The second magnetic element is configured as a thin magnetic film deposited on the surface of the first substrate opposite to the surface where the first magnetic is arranged. In one example, the second magnetic element includes a FeSib alloy.

As illustrated in FIG. 1(a) at first a first substrate 100 is provided. On the first substrate 100 first conduction strip lines 101a-101n are deposited by means of, for example, a vacuum deposition technique. The first conductive strip lines 101a-101n respectively form a first conductive path of an inductor element and flip chip inductor, respectively, which are provided by the embodiment. The first conductive strip lines 101a-101n consist of metal layers.

Then, in the next step as illustrated in FIG. 1(b) first conductive studs 102a-102n and second conductive studs 103a-103n are deposited onto end terminals of the first conductive strip lines 101a-101n which are deposited onto the first substrate 100. The first and second conductive studs project from the surface of the substrate 100 by typically 50 μm. In one embodiment, the first 102a-102n and second conductive studs 103a-103n are provided as pillar bumps.

The first 102a-102n and second conductive studs 103a-103n include copper or copper alloys. Furthermore it is possible to provide other materials such as Ag. In one case, the first 102a-102n and the second conductive studs 103a-103n are deposited onto the at least one conductive strip line at the end terminals thereof by using a plating process.

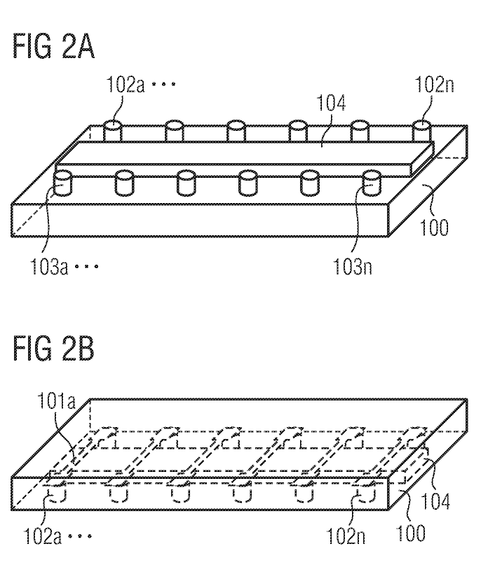

FIG. 2(a) illustrates the next step for forming an inductor element according to an embodiment. It is noted that this step can be omitted, if low inductivity conductor elements are to be provided. This step, which is illustrated in FIG. 2(a), aims at providing high inductivity inductor elements by increasing inductance of a magnetic coil by means of a magnetic core. As illustrated in FIG. 2(a) a first magnetically soft core element 104 is provided between the first 102a-102n and second conductive studs 103a-103n and on top of the first substrate 100 and on top of the first conductive strip lines 101a-101n which are deposited onto the top surface of the first substrate 100.

The first magnetically soft core element 104 may include a ferromagnetic material. The first magnetically soft core element 104 includes FeSiB alloy. The material of the first magnetically soft core element 104 is deposited between the first 102a-102n and second conductive studs 103a-103n and on the at least one first conductive strip line 101a-101n by using a vacuum deposition technique. Furthermore it is possible to arrange the first magnetically soft core element 104 as a separate piece of material in a region between the first 102a-102n and second conductive studs 103a-103n on the surface of the first substrate 100. At the end of the process steps illustrated FIG. 2(a) and inductor element according to one embodiment is formed.

FIG. 2(b) depicts the inductor element illustrated in FIG. 2(a) flipped by 180° such that the first 102a-102n and second conductive studs 103a-103n now point downwards, that is, the substrate 100 now is illustrated from the bottom side of the FIG. 2(a).

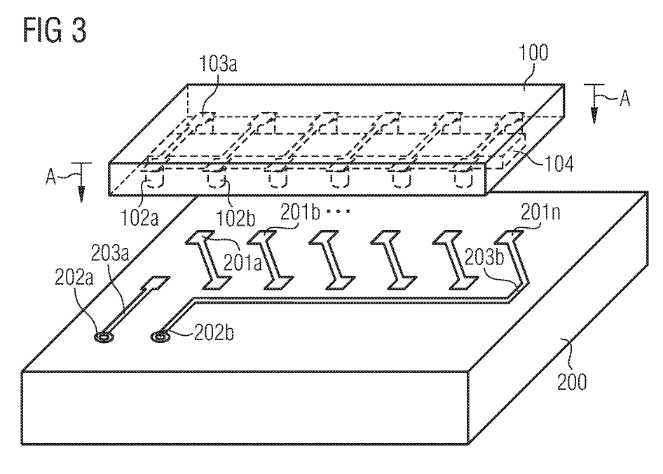

The next processing step is illustrated in FIG. 3. In order to complete a flip chip inductor a second substrate 200 is provided, which includes at least one second conductive strip line 201a-201n having end terminals. The second conductive strip line 201a-201n is deposited onto the surface of the second substrate, as illustrated in FIG. 3.

Furthermore inductor connection terminals 202a, 202b and connection strip lines 203a, 203b are deposited onto the surface of the second substrate 200. With respect to the deposition processes, same deposition processes as described with respect to the first substrate 100 (see FIG. 1(a), 1(b) and 2(a), 2(b) may be used such as a vacuum deposition technique and/or a plating process. The second conductive strip lines 201a-201n, the inductor connection terminals 202a, 202b and the connection strip lines 203a, 203b consist of metal layers.

Thereby a pitch of the end terminals of the second conductive strip lines 201a-201n corresponds to the pitch of the end terminals of the first conductive strip line 101a-101n. Thus, as illustrated in FIG. 3, the inductor connection terminal 202a is connected to the first conductive stud 102a, wherein the second conductive strip line 101a connects the second conductive stud 103a with the first conductive stud 102b, and so on. As a result a conducting path is formed around the first magnetically soft core element 104. Using the method according to one embodiment a long coil may be provided.

In order to connect the respective end terminals of the first conductive strip lines 101a-101n with the appropriate end terminals of the second conductive strip lines 201a-201n the substrate 100 which has been flipped by 180° (see FIG. 2) is arranged on top of the surface of the second substrate 200 by moving the first substrate 100 in the direction of arrows A.

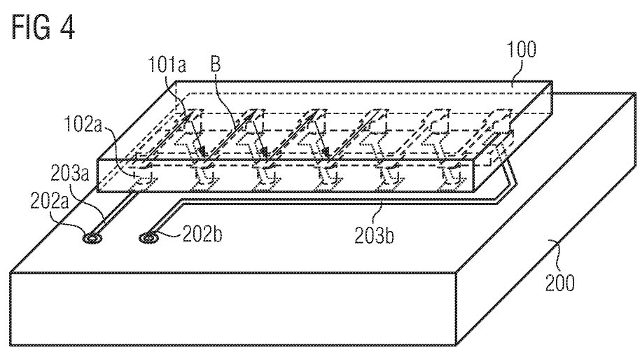

The result of this operation is illustrated in FIG. 4 where a conductive path is indicated by arrows B. Thus a flip chip inductor according to a first embodiment is formed.

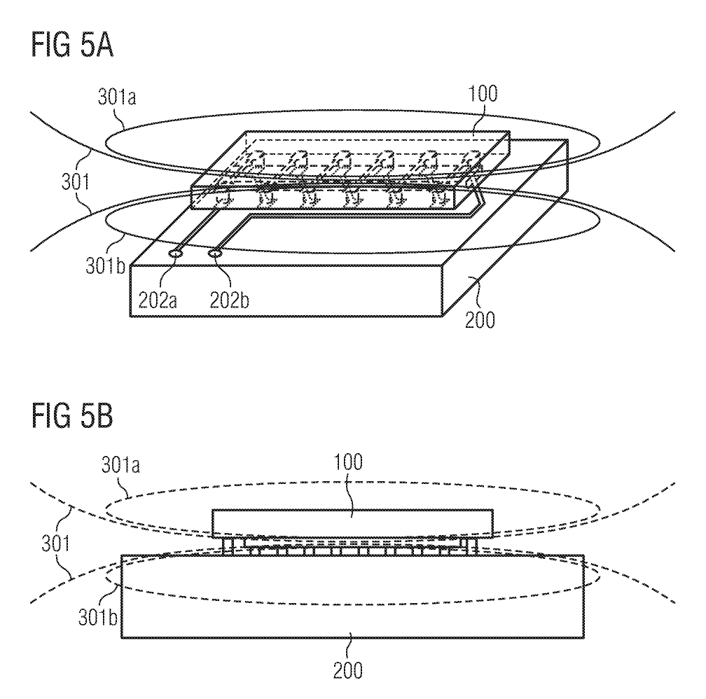

FIG. 5 illustrates the magnetic field line configuration of the flip chip inductor according to the first embodiment. The magnetic field line 301 illustrated in FIG. 5(a) consists of first magnetic field line 301a above the bottom side of the substrate 100 and second magnetic field lines 301b which pass through the second substrate 200. FIG. 5(b) illustrates this situation in more detail. FIG. 5(b) is a sectional view along the axis of the flip chip inductor.

An aspect of the present embodiment is that the second magnetic field lines 301b may pass through the second substrate 200 such that electronic components integrated into the second substrate 200 may be affected by the magnetic field produced by the flip chip inductor.

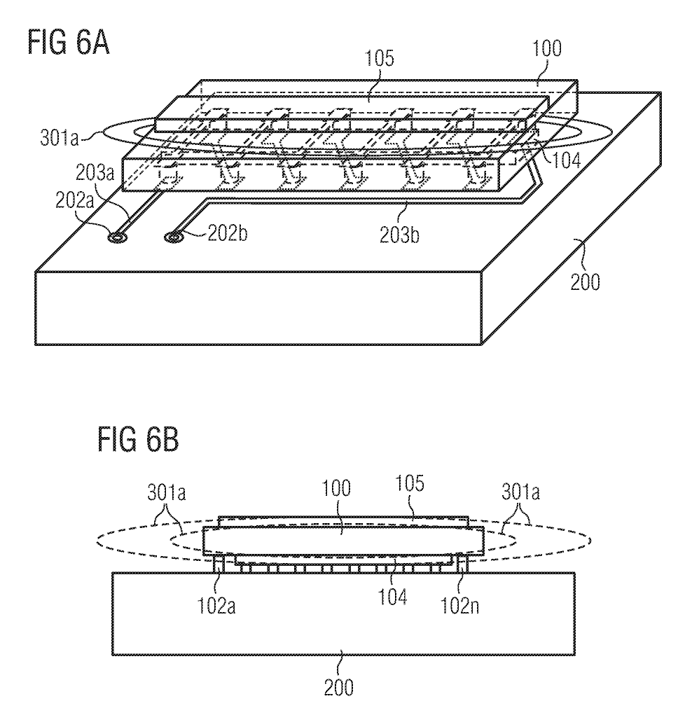

In order to avoid this, a second embodiment a second magnetically soft core element 105 which is illustrated in FIGS. 6(a) and 6(b). The second magnetically soft core element 105 is deposited onto the bottom side of the first substrate 100, that is, the second magnetically soft core element 105 is arranged at the first substrate 100 on a surface opposite to the surface where the first magnetically soft core element 104 is arranged as illustrated in FIG. 6(a).

Now only first magnetic field lines 301a pass through the second magnetically soft core element 105 and not anymore through the second substrate 200. FIG. 6(b) illustrates this situation in more detail, as FIG. 6(b) is a sectional view across the access of the flip chip inductor. The magnetic field lines are completely diverted from the first magnetically soft core element 104 through the second magnetically soft core element 105.

Thus, with the second embodiment, electronic components provided in the second substrate 200 are not affected by any magnetic field produced by the flip chip inductor as the first magnetically soft core element 104 and the second magnetically soft core element 105 may be configured as a thin magnetic film deposited onto the bottom surface of the first substrate 100. The second magnetically soft core element includes FeSiB alloy.

In the following, an estimation of the inductance of the flip chip inductor according to the first and second embodiments will be given. It is assumed that the length of the flip chip inductor is 1.5 mm, the width of the flip chip inductor is 0.5 mm and the magnetic permeability μᵣ of the first magnetically soft core element 104 is 100,000.

Assuming a cross section of the first magnetically soft core element 104 of A=25 μm×30 μm and a number of windings of n=13 corresponding to a pitch of 100 μm (that is, the distance from one conductive stud to the neighbouring conductive stud) yields an effective coil length of 1=13 mm. The inductivity of L of the flip chip inductor thus formed is given by the following equation:

L=μ₀μᵣAn²/1˜200 nH,

where μ₀ is the magnetic permeability of vacuum.

With some embodiments, the height of the flip chip inductor may be magnificently decreased down to, for example, 0.2 mm.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A chip device comprising:
a first substrate comprising at least one first conductive strip line having end terminals at a surface of the first substrate;
a second substrate comprising at least one second conductive strip line having end terminals at a surface of the second substrate, wherein a pitch of the end terminals on the first substrate corresponds to a pitch of the end terminals on the second substrate; and
conductive studs connecting the end terminals on the first substrate with the end terminals on the second substrate to form an inductor loop.

2. The chip device according to claim 1, wherein the first and/or the second substrate comprises a semiconductor circuit.

3. The chip device according to claim 1, wherein the first and/or the second conductive strip line comprises metal.

4. The chip device according to claim 1, wherein the first and second conductive studs are configured as pillar bumps.

5. The chip device according to claim 1, wherein the first and second conductive studs comprise copper or copper alloys.

6. The chip device according to claim 1, wherein a first magnetic element is arranged within the inductor loop.

7. The chip device according to claim 6, wherein the first magnetic element comprises a soft core material.

8. The chip device according to claim 7, wherein the first magnetic element comprises a FeSiB alloy.

9. The chip device according to claim 1, wherein the inductor further comprises a second magnetic element arranged at the first substrate on a surface opposite to the surface where end terminals of the conductive first strip line are arranged.

10. The chip device according to claim 9, wherein the second magnetic element comprises a soft core material.

11. The chip device according to claim 10, wherein the first magnetic element comprises a FeSiB alloy.

12. A method for manufacturing a semiconductor chip inductor, comprising:
providing a first substrate;
depositing at least one first conductive strip line having end terminals onto the first substrate;
providing a second substrate;
depositing at least one second conductive strip line having end terminals onto the second substrate, wherein a pitch of the end terminals on the first substrate corresponds to a pitch of the end terminals on the second substrate; and
depositing conductive studs onto the end terminals on the first and/or the second substrate;
arranging the first substrate with respect to the second substrate such that the conductive studs connect the end terminals on the first substrate with the end terminals on the second substrate to form an inductor loop.

13. The method according to claim 12, wherein depositing conductive studs onto the end terminals is performed by a plating process.

14. The method according to claim 12, wherein depositing conductive studs onto the end terminals is performed by a bumping process.

15. The method according to claim 12, further comprising arranging a first magnetic element within the conductor loop.

16. The method according to claim 15, wherein arranging the first magnetic element is performed by using a vacuum deposition technique.

17. The method according to claim 12, further comprising arranging a second magnetic element at the first substrate on a surface opposite to the surface where end terminals of the conductive first strip line are arranged.

18. The method according to claim 17, wherein arranging the second magnetic element is performed by using a vacuum deposition technique.

19. The method according to claim 12, wherein arranging the first substrate with respect to the second substrate is performed using a flip chip technique.

20. A semiconductor device comprising:
a first substrate comprising at least one first conductive strip line;
a second substrate comprising at least one second conductive strip line; and
means for connecting the first and second strip lines to form an inductor loop.

21. The semiconductor device of claim 21, further comprising:
end terminals on the at least one first conductive strip line at a surface of the first substrate; and
end terminals on the at least one second conductive strip line at a surface of the second substrate;
wherein a pitch of the end terminals on the first substrate corresponds to a pitch of the end terminals on the second substrate.
